(19) United States
(12) Patent Application Publication
(10) Pub. No.: US 2022/0311917 A1
(43) Pub. Date: Sep. 29, 2022

(54) OPTICAL SYSTEM, CAMERA MODULE, AND ELECTRONIC APPARATUS

(71) Applicant: JIANGXI JINGCHAO OPTICAL CO., LTD., Nanchang (CN)

(72) Inventors: Jian YANG, Nanchang (CN); Ming LI, Nanchang (CN); Linbo ZHU, Nanchang (CN); Hairong ZOU, Nanchang (CN)

(73) Assignee: JIANGXI JINGCHAO OPTICAL CO., LTD., Nanchang (CN)

(21) Appl. No.: 17/611,162

(22) PCT Filed: Apr. 29, 2020
(86) PCT No.: PCT/CN2020/087819

§ 371 Date: Nov. 14, 2021

(51) Int. Cl. H04N 5/225; G02B 9/60; G02B 13/00; G02B 1/04

(52) U.S. Cl. CPC H04N 5/2254; G02B 9/60; G02B 13/0045; G02B 1/041

(57) ABSTRACT

An optical system includes, sequentially along an incident optical path, a lens element including at least one lens and having a positive refractive power, and an optical path adjusting element including an incident surface and at least one effective reflective surface. The incident surface faces an image side of the lens element, and a light beam from the lens element is capable of passing through the incident surface to enter the optical path adjusting element, and is reflected at the effective reflective surface. The optical system satisfies the following condition: SDL/SDF<1.5. SDL is a size of an aperture of an image-side surface of a lens closest to the image side in the lens element, and SDF is a size of an aperture of the incident surface.

### CROSS-REFERENCE TO RELATED APPLICATIONS

This application is a national stage, filed under 35 U.S.C. § 371, of International Patent Application No. PCT/CN2020/087819, filed on Apr. 29, 2020, and entitled “OPTICAL SYSTEM, CAMERA MODULE, AND ELECTRONIC DEVICE”, the content of which is incorporated herein by reference in its entirety.

### TECHNICAL FIELD

The present disclosure relates to the field of camera technologies, and particularly, to an optical system, a camera module, and an electronic device.

### BACKGROUND

In recent years, with the popularization of portable electronic devices such as smart phones and smart watches, the camera performance of the devices has attracted more and more attention from the market. In particular, in order to meet the market's demand for telephoto and super-telephoto camera performance, lenses with ultra-long focal length have emerged. However, since this type of lens generally has a long back focus, it generally occupies a larger space of the device, which causes excessively large thickness of the device. In addition, the images taken by such telephoto lenses often suffer from insufficient brightness. Hence, how to solve the problem that the module can still obtain an imaging picture with sufficient brightness under the premise of having telephoto characteristics, and the miniaturization of the device cannot be restricted due to the overlarge dimension of the module, has become one of the major concerns in the industry.

### SUMMARY

According to various embodiments of the present disclosure, an optical system is provided.

The optical system includes, sequentially along an incident optical path, a lens element including at least one lens and having a positive refractive power; and an optical path adjusting element including an incident surface and at least one effective reflective surface, the incident surface facing an image side of the lens element, and a light beam from the lens element being capable of passing through the incident surface to enter the optical path adjusting element, and being reflected at the effective reflective surface, wherein the optical system satisfies the following condition:

SDL/SDF<1.5

wherein SDL is a size of an aperture of an image-side surface of a lens closest to the image side in the lens element, and SDF is a size of an aperture of the incident surface.

Also provided is a camera module including an image sensor and the above-mentioned optical system. The image sensor is configured to receive a light beam from the optical path adjusting element.

Further provided is an electronic device including a fixing member and the above-mentioned camera module arranged on the fixing member.

### BRIEF DESCRIPTION OF THE DRAWINGS

To better describe and illustrate the embodiments and/or examples of the disclosure disclosed herein, reference may be made to one or more accompanying drawings. The additional details or examples used to describe the accompanying drawings are not to be construed as limiting the scope of any one of the disclosed disclosure, the presently described embodiments and/or examples, and the presently understood preferred mode of the disclosure.

FIG. 1 is an axonometric view of a camera module provided with an optical system in a first embodiment of the present disclosure;

FIG. 2 is a side view of the camera module shown in FIG. 1;

FIG. 3 shows diagrams of longitudinal spherical aberration, astigmatism, and distortion of the camera module in the first embodiment;

FIG. 4 is a schematic view of a camera module provided with an optical system in a second embodiment of the present disclosure;

FIG. 5 shows diagrams of longitudinal spherical aberration, astigmatism, and distortion of the camera module in the second embodiment;

FIG. 6 is an axonometric view of a camera module provided with an optical system in a third embodiment of the present disclosure;

FIG. 7 is a schematic view of a part of the structure of the camera module shown in FIG. 6;

FIG. 8 shows diagrams of longitudinal spherical aberration, astigmatism, and distortion of the camera module in the third embodiment;

FIG. 9 is a schematic view of a camera module provided with an optical system in a fourth embodiment of the present disclosure;

FIG. 10 shows diagrams of longitudinal spherical aberration, astigmatism, and distortion of the camera module in the fourth embodiment;

FIG. 11 is a schematic view of a camera module provided with an optical system in a fifth embodiment of the present disclosure;

FIG. 12 shows diagrams of longitudinal spherical aberration, astigmatism, and distortion of the camera module in the fifth embodiment; and

FIG. 13 is a schematic view of an electronic device according to an embodiment of the present disclosure.

### DETAILED DESCRIPTION OF THE EMBODIMENTS

For the convenience of understanding the present disclosure, embodiments of the disclosure are described more fully hereinafter with reference to the accompanying drawings. Preferable embodiments of the present disclosure are presented in the accompanying drawings. However, the present disclosure may be embodied in many different forms and is not limited to the embodiments described herein. On the contrary, these embodiments are provided to make the understanding of the disclosure of the present disclosure more thorough.

It should be noted that when an element is referred to as being “fixed to” another element, it can be directly fixed to another element or indirectly connected to another element with a mediating element. When an element is considered to be “connected to” another element, it can be directly connected to another element or indirectly connected to another element with a mediating element. The terms “inside”, “outside”, “left”, “right”, and the like used herein are for illustrative purposes only and are not intended to indicate the only example.

For lenses with telephoto characteristics, this type of lens have a large back focal length, which causes that a module needs to leave a larger space along an axial direction of the lens to match the long focal length of the lens, so that light beams from the lens can be converged to image sensors. However, this structure often leads to excessively large axial dimensions of the module, which is not conducive to assembly in the device, and restricts the thickness reduction of the device. In addition, the images taken by such telephoto lenses often suffer from insufficient brightness. Hence, how to solve the problem that the module can still obtain an imaging picture with sufficient brightness under the premise of having telephoto characteristics, and the miniaturization of the device cannot be restricted due to the overlarge dimension of the module, has become one of the major concerns in the industry.

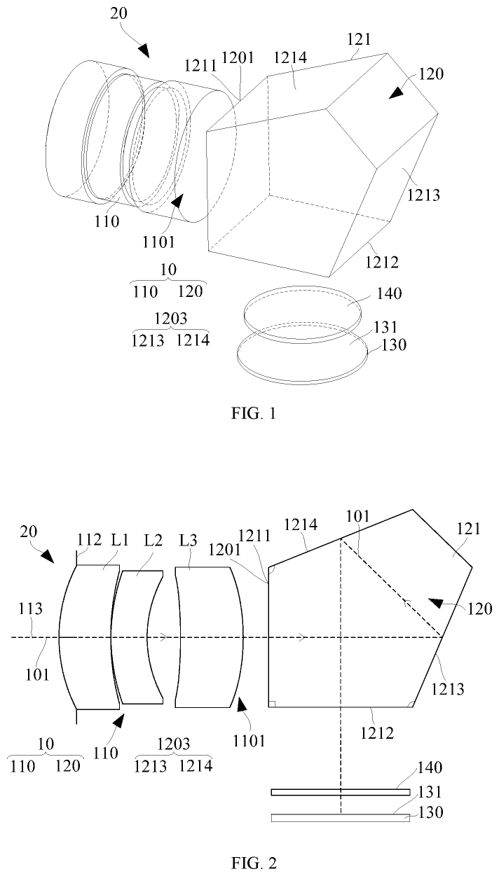

Referring to FIGS. 1 and 2, which show that a camera module 20 in an embodiment of the present disclosure sequentially includes, along an incident optical path 101, an optical system 10 and an image sensor 130. The optical system 10 sequentially includes, along the incident optical path 101, a lens element 110 and an optical path adjusting element 120. The lens element 110 includes a stop 112 and at least one lens (referring to FIG. 2), for example, one, two, three, four, five or more lenses. The optical axis of the lens is in the same straight line with the center of the stop 112, and when there are more than two lenses, the optical axes of the lenses are arranged collinearly, and the optical axis of each lens can be considered as the optical axis 113 of the lens element 110. The lens element 110 can provide a positive refractive power for the system to converge incident light.

The optical path adjusting element 120 includes an incident surface and at least one effective reflective surface 1203, and the incident surface faces an image side 1101 of the lens element 110. The incident surface is a plane, and the optical axis 113 of the lens element 110 is perpendicular to the incident surface. The number of effective reflective surfaces 1203 in the optical path adjusting element 120 may be one, two, three, or more. The effective reflective surface 1203 is a plane. When the number of effective reflective surfaces 1203 is multiple, the incident optical path 101 will pass through each effective reflective surface 1203 in turn. The light beam from the lens element 110 can pass through the incident surface to enter the optical path adjusting element 120, and be reflected at the effective reflective surface 1203 to change optical propagation path. In other words, the existence of the effective reflective surface 1203 can change the orientation of the incident optical path 101 of the system, and prevent the light beam emitted from the lens element 110 from propagating in the same direction, which causes excessively large dimension of the optical system 10 in the axial direction (parallel to the optical axis 113 of the lens element 110). Specifically, the optical path adjusting element 120 may include at least one of polygonal prisms such as triangular prism, quadrangular prism, pentaprism, or the like. One surface of the prism serves as an incident surface 1201 of the optical path adjusting element 120, and at least another surface serves as the effective reflective surface 1203.

The image sensor 130 may be a charge coupled device (CCD) or a complementary metal oxide semiconductor (CMOS). The image sensor 130 includes a photosensitive surface 131 for receiving the light beam from the optical path adjusting element 120, and the photosensitive surface 131 coincides with an imaging surface of the optical system 10. Specifically, the incident optical path 101 of the system sequentially passes through the lens element 110, the incident surface 1201 of the optical path adjusting element 120, and the effective reflective surface 1203 of the optical path adjusting element 120, and then reaches the photosensitive surface 131 of the image sensor 130. It should be noted that the incident optical path 101 described herein represents an optical propagation path (referring to the dotted line in FIG. 2) of the light beam incident on the lens element 110 along the optical axis 113 of the lens element 110.

On the other hand, the optical system 10 satisfies the following condition: SDL/SDF<1.5; wherein SDL is a size of an aperture (effective clear aperture) of an image-side surface of the last lens (closest to the image side 1101) in the lens element 110, and SDF is a size of an aperture (effective clear aperture) of the incident surface 1201 of the optical path adjusting element 120. It should be noted that when the incident surface is a rectangular plane, the SDF is a maximum side length of the rectangular plane; when the incident surface is a circular plane, the SDF is a diameter of the circular plane. In some embodiments, SDL/SDF may be 0.86, 0.88, 0.9, 0.92, 0.95, 1, 1.05, 1.1, 1.12 or 1.13.

In the above-mentioned optical system 10, by providing the optical path adjusting element 120 on the emergent optical path of the lens element 110, the light beam from the lens element 110 can be reflected in the optical path adjusting element 120 to change the optical propagation path, thereby reducing the dimension of the module in the axial direction (parallel to the optical axis 113 of the lens element 110), and further reducing the space occupied by the module in the thickness direction of the device, so that an ultra-thin design of the device can be realized. It should be noted that, the back focus length of the module is not reduced in the above structure, while the optical propagation path of the light beam emitted from the lens element 110 is bent so as to allow the optical system 10 to maintain the telephoto characteristic. Furthermore, when the optical system 10 satisfies the above-mentioned conditions, the aperture of the incident surface can be configured well with the aperture of the image-side surface of the last lens in the lens element 110, so as to effectively increase the collection of the light beam from the lens element 110 by the optical path adjusting element 120, and increase the brightness of the imaging picture, thereby improving the imaging quality of the module.

In some embodiments, the optical system 10 further satisfies the following condition: BFL/SDM>2; wherein BFL is a distance on the incident optical path 101 from the center of the image-side surface of the lens closest to the image side 1101 in the lens element 110 toward the photosensitive surface 131, and SDM is the maximum value among the apertures (effective clear apertures) of all the effective reflective surfaces 1203. In some embodiments, BFL/SDM may be 2.5, 2.6, 2.7, 2.8, 3, 3.5, 3.6, 3.7 or 3.8. When the above condition is satisfied, the axial dimension of the optical system 10 can be effectively reduced.

In some embodiments, the object-side surface and image-side surface of each lens in the optical system 10 are aspherical. The aspherical design can lead to a more flexible design for the object-side surface and/or image-side surface of the lens, so that undesirable phenomena such as unclear imaging, distortion of the field of view, narrow field of view can be solved well when the lens is small and thin. In this way, the system can achieve good imaging quality without arranging too many lenses, and it helps to shorten the length of the optical system 10. In some embodiments, the object-side surface and the image-side surface of each lens in the optical system 10 are spherical, and the spherical lens has simple manufacturing process and low production cost. In other embodiments, in the optical system 10, the object-side surfaces of some lenses are aspherical, the object-side surfaces of other lenses are spherical, the image-side surfaces of some lenses are aspherical, and the image-side surfaces of other lenses are spherical. The specific configurations of the spherical surface and the aspherical surface in some embodiments are determined according to actual design requirements, and will not be repeated herein. The aberration of the system can also be effectively eliminated through the cooperation of the spherical and aspherical surfaces, so that the optical system 10 has good imaging quality, and the flexibility of both lens design and assembly is improved, so that the system can achieve a balance between high image quality and low cost.

In some embodiments, each lens in the optical system 10 is made of plastic. In other embodiments, each lens in the optical system 10 is made of glass. The plastic lens can reduce the weight of the optical system 10 and the manufacturing cost, while the glass lens can withstand higher temperatures and have excellent optical effects. In other embodiments, some of the lenses are made of glass, and the other part of the lenses are made of plastic. In this case, the combination of different materials can better balance the optical performance and cost of the system.

As described above, by adopting the above-mentioned optical system 10, the camera module 20 can also achieve corresponding effects.

### First Embodiment

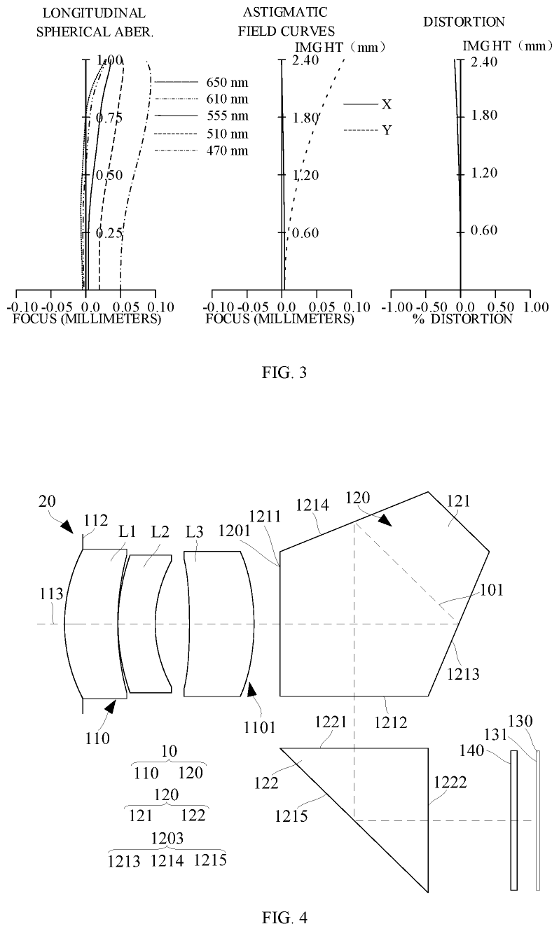

Referring to FIGS. 1 and 2, in the first embodiment, a camera module 20 sequentially includes, along an incident optical path 101, an optical system 10, an infrared filter 140 (the filter in the Table below), and an image sensor 130. The optical system 10 sequentially includes, along the incident optical path 101, a lens element 110 and an optical path adjusting element 120. FIG. 3 shows diagrams of longitudinal spherical aberration, astigmatism, and distortion of the camera module 20 in the first embodiment, and the reference wavelength of the astigmatism diagram and the distortion diagram in the following embodiments is 555 nm.

The lens element 110 includes a stop 112 and three lenses, the stop 112 is arranged on an object-side surface of the lens closest to the object side, and optical axes of the three lenses are in the same straight line with a center of the stop 112. The three lenses are a first lens L1, a second lens L2, and a third lens L3, respectively. The first lens L1 has a positive refractive power, the second lens L2 has a negative refractive power, and the third lens L3 has a positive refractive power.

The first lens L1 includes an object-side surface and an image-side surface, the second lens L2 includes an object-side surface and an image-side surface, and the third lens L3 includes an object-side surface and an image-side surface.

The optical path adjusting element 120 in this embodiment includes a first optical path element 121 that is a pentaprism. The first optical path element 121 includes a first incident surface 1211, a first emergent surface 1212, and two effective reflective surfaces 1203. The first incident surface 1211 is an incident surface 1201 of the optical path adjusting element 120, and the two effective reflective surfaces 1203 are a first reflective surface 1213 and a second reflective surface 1214, respectively. The first incident surface 1211 faces the lens element 110 and is perpendicular to an optical axis 113 of the lens element 110. Specifically, one end of the first incident surface 1211 is connected to the first emergent surface 1212, and the other end oppositely is connected to the second reflective surface 1214. The first emergent surface 1212 is connected to the first reflective surface 1213 at an end away from the first incident surface 1211. In addition, the first incident surface 1211 is perpendicular to the first emergent surface 1212, the first incident surface 1211 and the second reflective surface 1214 form an angle of 112.5°, and the first emergent surface 1212 and the first reflective surface 1213 form an angle of 112.5°. The incident optical path 101 of the system sequentially passes through the first incident surface 1211, the first reflective surface 1213, the second reflective surface 1214, and the first emergent surface 1212, and finally reaches the image sensor 130. In the above-mentioned design, the incident optical path 101 is perpendicular to the first incident surface 1211 when passing through the first incident surface 1211, and perpendicular to the first emergent surface 1212 when passing through the first emergent surface 1212. The optical path adjusting element 120 can reflect the light beam from the lens element 110 twice, so that the incident optical path 101 can be well adjusted to reduce the dimension of the module in the axial direction. The infrared filter 140 is configured to filter out infrared light.

Parameters of some elements of the camera module 20 are given in Tables 1 and 2. Table 2 shows aspherical coefficients of the lens surfaces with corresponding numbers in Table 1, wherein K is a conic coefficient, and Ai is a coefficient corresponding to the high-order term of the i-th term in the Formula of the aspherical shape. Along the incident optical path 101, the elements of the camera module 20 are arranged in the order of the elements in Table 1 from top to bottom. An image plane is a photosensitive surface 131 of the image sensor 130. Generally, the photosensitive surface 131 is an imaging plane of the optical system 10. The numbers 1 and 2 correspond to the object-side surface and the image-side surface of the first lens L1, respectively. That is, in the same lens, a surface with the smaller number is the object-side surface, and a surface with the larger number is the image-side surface. The Y radius in Table 1 is a radius of curvature of the object-side surface or the image-side surface with the corresponding number at the optical axis 113. The first value of the lens in the “thickness” parameter column is a thickness of the lens on the optical axis 113, and the second value therein is a distance on the optical axis 113 from the image-side surface of the lens toward the object-side surface of the subsequent element. It should be noted that, in this embodiment, the first value (corresponding to Number 7) of the first optical path element 121 in the “thickness” parameter column is a distance on the incident optical path 101 from the first incident surface 1211 toward the first reflective surface 1213, the second value (corresponding to Number 8) is a distance on the incident optical path 101 from the first reflective surface 1213 toward the second reflective surface 1214, the third value is a distance on the incident optical path 101 from the second reflective surface 1214 toward the first emergent surface 1212, and the fourth value is a distance on the incident optical path 101 from the first emergent surface 1212 toward the infrared filter 140. In addition, the X half aperture parameter (mm) corresponding to Number 7 is half of a side length of the first incident surface 1211 in the X direction, and the Y half aperture parameter (mm) is half of a side length of the first incident surface 1211 in the Y direction. Numbers 8, 9, and 10 correspond to the first reflective surface 1213, the second reflective surface 1214, and the first emergent surface 1212, respectively. The explanations of their respective X half aperture and Y half aperture can be derived from the above description, and will not be repeated herein.

The value of the stop 112 in the “thickness” parameter column is a distance on the optical axis 113 from the stop 112 toward the vertex (the vertex refers to an intersection of the lens and the optical axis 113) of the object-side surface of the subsequent lens. By default, the direction from the object side toward the image side is the positive direction of the optical axis 113. When the value is negative, it indicates that the stop 112 is arranged on the right side of the vertex of the object-side surface of the lens (i.e., the vertex of the object-side surface passes through the stop 112). When the “thickness” parameter of the stop 112 is positive, the stop 112 is on the left side of the vertex of the object-side surface of the lens. The optical axis of each lens in the embodiment of the present disclosure is on the same straight line, which acts as the optical axis 113 of the lens element 110. The reference wavelength of the parameter table in the following embodiments is 555 nm.

As shown in Table 1, in the first embodiment, in the lens element 110, a focal length f is 25.3 mm, an f-number FNO is 4.9, and half of a diagonal field of view HFOV is 5.4°.

TABLE 1
First embodiment
f = 25.3 mm, FNO = 4.9, HFOV = 5.4°

| | | | | | | | | Focal | | |
|---|---|---|---|---|---|---|---|---|---|---|
| | Surface | Surface | Y radius | Thickness | | Refractive | Abbe | length | Y half | X half |
| Number | Name | Type | (mm) | (mm) | Material | index | number | (mm) | aperture | aperture |
| | Object plane | Spherical | Infinite | Infinite | | | | | | |
| | Stop | Spherical | Infinite | −0.612 | | | | | 2.582 | 2.582 |
| 1 | First | Spherical | 5.701 | 1.797 | Glass | 1.476 | 81.567 | 26.385 | 2.582 | 2.582 |
| 2 | lens | Spherical | 9.386 | 0.010 | | | | | 2.380 | 2.380 |
| 3 | Second | Aspherical | 6.918 | 1.254 | Plastic | 1.644 | 23.517 | −24.536 | 2.378 | 2.378 |
| 4 | lens | Aspherical | 4.470 | 1.159 | | | | | 2.180 | 2.180 |
| 5 | Third | Aspherical | −19.655 | 2.180 | Plastic | 1.536 | 55.751 | 23.101 | 2.223 | 2.223 |
| 6 | lens | Aspherical | −7.898 | 0.882 | | | | | 2.507 | 2.507 |
| 7 | Pentaprism | Spherical | Infinite | 6.036 | Glass | 1.518 | 64.166 | | 2.500 | 2.500 |
| 8 | | Spherical | Infinite | −5.00 | | | | | 2.706 | 2.500 |
| 9 | | Spherical | Infinite | 6.036 | | | | | 2.706 | 2.500 |
| 10 | | Spherical | Infinite | 7.882 | | | | | 2.500 | 2.500 |
| 11 | Filter | Spherical | Infinite | 0.210 | Glass | 1.518 | 64.166 | | 2.407 | 2.407 |
| 12 | | Spherical | Infinite | 0.653 | | | | | 2.407 | 2.407 |
| | Image plane | Spherical | Infinite | | | | | | 2.404 | 2.404 |

TABLE 2
First embodiment
Aspherical coefficient

| Num- | | | | |
|---|---|---|---|---|
| ber | 3 | 4 | 5 | 6 |
| K | 0.0000E+00 | 0.0000E+00 | 0.0000E+00 | 0.0000E+00 |
| A4 | −4.3423E−04 | −2.0016E−04 | −1.0392E−03 | −9.3641E−04 |
| A6 | −2.2784E−05 | −1.0182E−04 | −2.0509E−04 | −8.3558E−05 |
| A8 | −1.1047E−06 | −6.6133E−06 | 3.2047E−06 | 1.2851E−06 |
| A10 | 4.6427E−07 | 1.2153E−06 | −1.6590E−06 | −2.4820E−07 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

The calculation of a surface shape of the aspherical surface can refer to the Formula of the aspherical shape:

$$Z = \frac{c {r}^{2}}{1 + \sqrt{1 - ( k + 1 ) {c}^{2} {r}^{2}}} + {\sum }_{i} Ai {r}^{i}$$

where, Z is a distance from a corresponding point on the aspherical surface toward a plane tangent to a vertex of the surface, r is a distance from the corresponding point on the aspherical surface to the optical axis 113, c is a curvature of a vertex of the aspherical surface, k is a conic coefficient, and Ai is a coefficient corresponding to the high-order term of the i-th term in the Formula of the aspherical shape.

In addition, in this embodiment, the refraction or reflection of an incident light beam on the surfaces with corresponding numbers is given in the following Table:

| Number | Surface Name | | |
|---|---|---|---|
| | Object plane | | |
| | Stop | | |
| 1 | First lens | Refraction | |
| 2 | | Refraction | |
| 3 | Second lens | Refraction | |
| 4 | | Refraction | |
| 5 | Third lens | Refraction | |
| 6 | | Refraction | |
| 7 | Pentaprism | Refraction | |
| 8 | | Reflection | Eccentricity and bending |
| 9 | | Reflection | Eccentricity and bending |
| 10 | | Refraction | |
| 11 | Filter | Refraction | |
| 12 | | Refraction | |
| | Image plane | Refraction | |

In the first embodiment, the optical system 10 satisfies the following condition: SDL/SDF=1.003; wherein SDL is a size of an aperture of the image-side surface of the third lens L3, and SDF is a size of an aperture of the incident surface. In this embodiment, the first incident surface 1211 is a rectangular plane, so the SDF is the maximum side length of the rectangular plane, i.e., 5 mm. In this embodiment, the third lens L3 is the lens closest to the image side 1101, so the SDL is the size of the effective aperture of the image-side surface of the third lens L3. When the above-mentioned conditions are satisfied, the collection of the light beam from the lens element 110 by the optical path adjusting element 120 can be effectively increased, thereby increasing the brightness of the imaging picture, and improving the imaging quality of the module.

In addition, the optical system 10 further satisfies the following condition: BFL/SDM=4.93; wherein BFL is a distance on the incident optical path 101 from the center of the image-side surface of the lens closest to the image side 1101 in the lens element 110 toward the photosensitive surface 131, and SDM is the maximum value among the apertures of all the effective reflective surfaces 1203. In this embodiment, the first reflective surface 1213 and the second reflective surface 1214 of the optical path adjusting element 120 are both rectangular planes. By comparing the X half aperture and Y half aperture of the two, the SDM can be determined as 5.412 mm. When the above condition is satisfied, the axial dimension of the optical system 10 can be effectively reduced, thereby facilitating the small-size design of the camera module 20.

### Second Embodiment

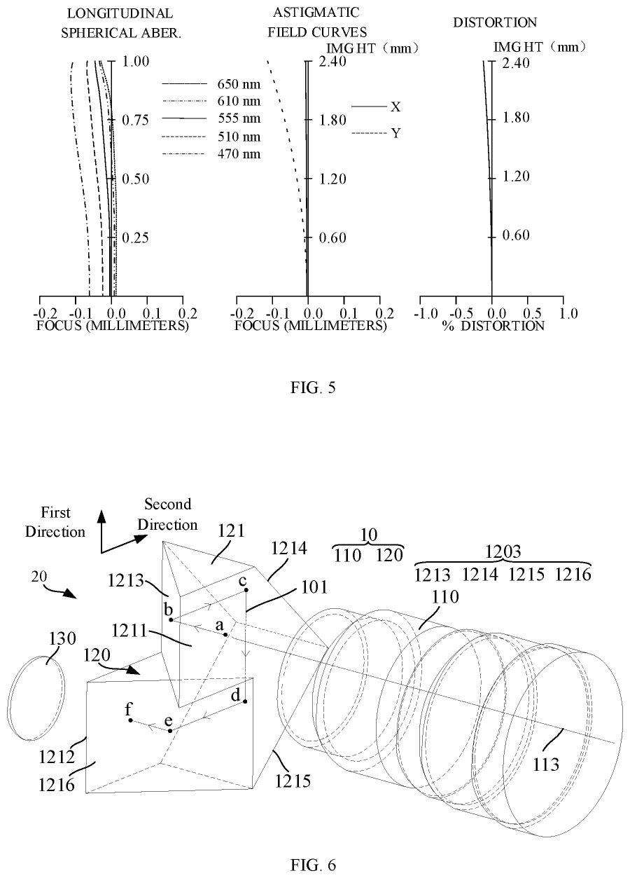

Referring to FIG. 4, in the second embodiment, a camera module 20 sequentially includes, along an incident optical path 101, an optical system 10, an infrared filter 140, and an image sensor 130. The structures of the lens element 110 are the same as those in the first embodiment, and the first optical path element 121 in the optical path adjusting element 120 is also the same as that in the first embodiment. The main difference is that the optical path adjusting element 120 further includes a second optical path element 122 that is a right triangular prism. One right-angled surface of the second optical path element 122 is a second incident surface 1221, the other right-angled surface is a second emergent surface 1222, and an inclined surface acts as a third reflective surface 1215 of the optical path adjusting element 120, i.e., an effective reflective surface 1203 of the optical path adjusting element 120. The second incident surface 1221 is directly opposite to the first emergent surface 1212, and the second emergent surface 1222 is directly opposite to the infrared filter 140. The light beam emitted from the first reflective surface 1213 of the first optical path element 121 can enter the second optical path element 122 from the second incident surface 1221, and is internally reflected at the inclined surface, and then is emitted from the second emergent surface 1222 to the infrared filter 140, and finally reaches the image sensor 130. FIG. 5 shows diagrams of longitudinal spherical aberration, astigmatism, and distortion of the camera module 20 in the second embodiment.

In addition, the lens parameters in the second embodiment are given in Tables 3 and 4. The definitions of each structure and parameter can be obtained in the first embodiment, and will not be repeated here. In the following Table, the pentaprism is the first optical path element 121, and the triangular prism is the second optical path element 122. However, it should be noted that Number 11 in Table 3 corresponds to the second incident surface 1221 of the second optical path element 122, Number 12 corresponds to the third reflective surface 1215, and Number 13 corresponds to the second emergent surface 1222. The second incident surface 1221, the third reflective surface 1215, and the second emergent surface 1222 are all rectangular planes, and the definitions of the X half aperture (mm) and the Y half aperture (mm) can refer to the description of the above-mentioned embodiment.

TABLE 3
Second embodiment
f = 25.3 mm, FNO = 4.9, HFOV = 5.45°

| | | | | | | | | Focal | | |
|---|---|---|---|---|---|---|---|---|---|---|
| | Surface | Surface | Y radius | Thickness | | Refractive | Abbe | length | Y half | X half |
| Number | Name | Type | (mm) | (mm) | Material | index | number | (mm) | aperture | aperture |
| | Object plane | Spherical | Infinite | Infinite | | | | | | |
| | Stop | Spherical | Infinite | −0.612 | | | | | 2.582 | 2.582 |
| 1 | First | Spherical | 5.701 | 1.797 | Glass | 1.476 | 81.567 | 26.385 | 2.582 | 2.582 |
| 2 | lens | Spherical | 9.386 | 0.010 | | | | | 2.379 | 2.379 |
| 3 | Second | Aspherical | 6.918 | 1.254 | Plastic | 1.644 | 23.517 | −24.536 | 2.378 | 2.378 |
| 4 | lens | Aspherical | 4.470 | 1.159 | | | | | 2.180 | 2.180 |
| 5 | | Aspherical | −19.655 | 2.180 | Plastic | 1.536 | 55.751 | 23.101 | 2.223 | 2.223 |
| 6 | Third lens | Aspherical | −7.898 | 0.882 | | | | | 2.506 | 2.506 |
| 7 | Pentaprism | Spherical | Infinite | 6.036 | Glass | 1.518 | 64.166 | | 2.500 | 2.500 |
| 8 | | Spherical | Infinite | −5.000 | | | | | 2.706 | 2.500 |
| 9 | | Spherical | Infinite | 6.036 | | | | | 2.706 | 2.500 |
| 10 | | Spherical | Infinite | 1.794 | | | | | 2.500 | 2.500 |
| 11 | Triangular | Spherical | Infinite | 2.500 | Glass | 1.518 | 64.166 | | 2.500 | 2.500 |
| 12 | prism | Spherical | Infinite | −2.500 | | | | | 3.536 | 2.500 |
| 13 | | Spherical | Infinite | −2.794 | | | | | 2.500 | 2.500 |
| 14 | Filter | Spherical | Infinite | −0.210 | Glass | 1.518 | 64.166 | | 2.408 | 2.408 |
| 15 | | Spherical | Infinite | −0.653 | | | | | 2.407 | 2.407 |
| | Image plane | Spherical | Infinite | 0.000 | | | | | 2.404 | 2.404 |

TABLE 4
Second embodiment
Aspherical coefficient

| Num- | | | | |
|---|---|---|---|---|
| ber | 3 | 4 | 5 | 6 |
| K | 0.0000E+00 | 0.0000E+00 | 0.0000E+00 | 0.0000E+00 |
| A4 | −4.3423E−04 | −2.0016E−04 | −1.0392E−03 | −9.3641E−04 |
| A6 | −2.2784E−05 | −1.0182E−04 | −2.0509E−04 | −8.3558E−05 |
| A8 | −1.1047E−06 | −6.6133E−06 | 3.2047E−06 | 1.2851E−06 |
| A10 | 4.6427E−07 | 1.2153E−06 | −1.6590E−06 | −2.4820E−07 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

In addition, in this embodiment, the refraction or reflection of an incident light beam on the surfaces with corresponding numbers is given in the following Table:

| Number | Surface Name | | |
|---|---|---|---|
| | Object plane | | |
| | Stop | | |
| 1 | First lens | Refraction | |
| 2 | | Refraction | |
| 3 | Second lens | Refraction | |
| 4 | | Refraction | |
| 5 | Third lens | Refraction | |
| 6 | | Refraction | |
| 7 | Pentaprism | Refraction | |
| 8 | | Reflection | Eccentricity and bending |
| 9 | | Reflection | Eccentricity and bending |
| 10 | | Refraction | |
| 11 | Triangular prism | Refraction | |
| 12 | | Refraction | |
| 13 | | Refraction | |
| 14 | Filter | Refraction | |
| 15 | | Refraction | |
| | Image plane | | |

The optical system 10 in this embodiment satisfies the following conditions:

| | | | |
|---|---|---|---|
| SDL/SDF | 1.003 | BFL/SDM | 4.02 |

In this embodiment, SDL is a size of an effective aperture of the image-side surface of the third lens L3. SDM is the maximum among the side lengths of the first reflective surface 1213, the second reflective surface 1214, and the third reflective surface 1215. Referring to Table 3, the side length of the third reflective surface 1215 corresponding to Number 12 in the Y direction is the maximum among the side lengths of the three surfaces. In this case, SDM is 7.071 mm.

### Third Embodiment

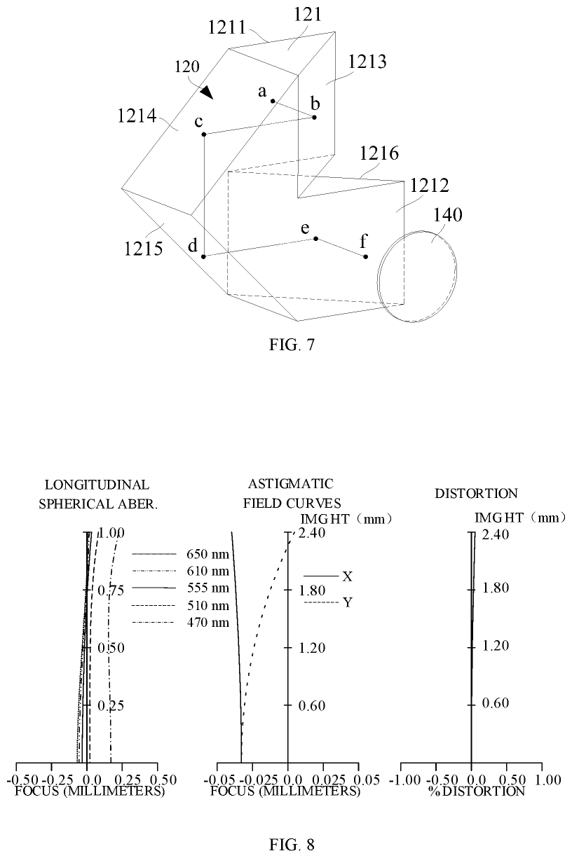

Referring to FIGS. 6 and 7, in the third embodiment, a camera module 20 sequentially includes, along an incident optical path 101, an optical system 10, an infrared filter 140 (the filter in the Table below, which is not shown in figures), and an image sensor 130. The optical system 10 sequentially includes, along the incident optical path 101, a lens element 110 and an optical path adjusting element 120. FIG. 8 shows diagrams of longitudinal spherical aberration, astigmatism, and distortion of the camera module 20 in the third embodiment.

The lens element 110 in this embodiment includes, sequentially from an object side toward an image side, a first lens with a negative refractive power, a second lens with a positive refractive power, a third lens with a positive refractive power, and a fourth lens with a positive refractive power, and a fifth lens with a positive refractive power. The first lens includes an object-side surface and an image-side surface, the second lens includes an object-side surface and an image-side surface, the third lens includes an object-side surface and an image-side surface, the fourth lens includes an object-side surface and an image-side surface, and the fifth lens includes an object-side surface and an image-side surface.

In particular, the optical path adjusting element 120 includes a first optical path element 121 including a first incident surface 1211, a first emergent surface 1212, and four effective reflective surfaces 1203. The first incident surface 1211 is an incident surface 1201 of the optical path adjusting element 120. The four effective reflective surfaces 1203 are a first reflective surface 1213, a second reflective surface 1214, a third reflective surface 1215, and a fourth reflective surface 1216, respectively. The incident optical path 101 sequentially passes through the first incident surface 1211, the first reflective surface 1213, the second reflective surface 1214, the third reflective surface 1215, the fourth reflective surface 1216, and the first emergent surface 1212. By providing four effective reflective surfaces 1203, the light from the lens element 110 can be reflected in the first optical path element 121 for a corresponding number of times, so that the incident optical path 101 is effectively bent in the first optical path element 121, thereby further reducing the dimension of the module in the axial direction.

The incident optical path 101 intersects with the first incident surface 1211 at point a, intersects with the first reflective surface 1213 at point b, intersects with the second reflective surface 1214 at point c, intersects with the third reflective surface 1215 at point d, intersects with the fourth reflective surface 1216 at point e, and intersects with the first emergent surface 1212 at point f. The incident optical path 101 between the first incident surface 1211 and the first reflective surface 1213 is a first optical path ab, the incident optical path 101 between the first reflective surface 1213 and the second reflective surface 1214 is a second optical path bc, the incident optical path 101 between the second reflective surface 1214 and a third reflective surface 1215 is a third optical path cd, the incident optical path 101 between the third reflective surface 1215 and the fourth reflective surface 1216 is a fourth optical path de, and the incident optical path 101 between the fourth reflective surface 1216 and the first emergent surface 1212 is a fifth optical path ef. The optical system 10 includes a first direction and a second direction, the first direction is perpendicular to the second direction, and both the first direction and the second direction are perpendicular to the optical axis 113 of lens element 110.

The first optical path ab is collinear with the optical axis 113 of the lens element 110, the second optical path bc is perpendicular to the first optical path ab, the third optical path cd is perpendicular to the first optical path ab and the second optical path bc, the fourth optical path de is parallel to the second optical path bc, and the fifth optical path ef is parallel to the first optical path ab. After entering the first optical path element 121, the light beam will reach the first reflective surface 1213 along a direction parallel to the optical axis 113 of the lens element 110. It is then reflected to the second reflective surface 1214 by the first reflective surface 1213 along the second direction, and then reflected to the third reflective surface 1215 by the second reflective surface 1214 along a direction opposite to the first direction, and then reflected to the fourth reflective surface 1216 by the third reflective surface 1215 along a direction opposite to the second direction, and finally reflected to the first emergent surface 1212 by the fourth reflective surface 1216 along a direction parallel to the optical axis 113 of the lens element 110.

The first reflective surface 1213 and the first incident surface 1211 form an angle of 45°, the second reflective surface 1214 and the third reflective surface 1215 are perpendicular to the first incident surface 1211, and the second reflective surface 1214 is perpendicular to the third reflective surface 1215. The fourth reflective surface 1216 forms an angle of 45° with the first incident surface 1211 and the first emergent surface 1212, respectively, and the first incident surface 1211 is parallel to the first emergent surface 1212.

Through the above design, the light beam entering the first optical path element 121 can propagate in the first direction and the second direction on part of the propagation path, so that the incident optical path 101 can be effectively bent in space, thereby effectively reducing the dimension of the module in the axial direction. In some embodiments, the first optical path element 121 is an integral structure, and the first optical path element 121 in this case is a special-shaped prism (see the following Table). In other embodiments, the first optical path element 121 is spliced and combined by four right-angled triangular prisms. Specifically, a right-angled surface of the prism and a right-angled surface of another prism are bonded, so that the right-angled triangular prisms are combined to form the first optical path element 121.

It should be noted that the first optical path element 121 in some embodiments also has four effective reflective surfaces 1203, but the specific arrangement and the reflection path of the effective reflective surfaces 1203 are not limited to those shown in FIGS. 6 and 7. For a structure with four effective reflective surfaces 1203, any arrangement that can bend the incident optical path 101 to shorten the axial length shall fall within the scope of the description of the present disclosure.

In addition, the lens parameters in the third embodiment are given in Tables 5 and 6. The definitions of each structure and parameter can be derived from the first embodiment, and will not be repeated here. However, it should be noted that Number 11 in Table 5 corresponds to the first incident surface 1211 of the first optical path element 121, Number 12 corresponds to the first reflective surface 1213, Number 13 corresponds to the second reflective surface 1214, Number 14 corresponds to the third reflective surface 1215, Number 15 corresponds to the fourth reflective surface 1216, and Number 16 corresponds to the first emergent surface 1212. The first incident surface 1211, the first reflective surface 1213, the second reflective surface 1214, the third reflective surface 1215, the fourth reflective surface 1216, and the first emergent surface 1212 are all rectangular planes, and the definitions of the X half aperture (mm) and the Y half aperture (mm) can refer to the description of the above-mentioned embodiment.

TABLE 5
Third Embodiment
f = 50.6 mm, FNO = 4.5, HFOV = 2.7°

| | | | | | | | | Focal | | |
|---|---|---|---|---|---|---|---|---|---|---|
| | Surface | Surface | Y radius | Thickness | | Refractive | Abbe | length | Y half | X half |
| Number | Name | Type | (mm) | (mm) | Material | index | number | (mm) | aperture | aperture |
| | Object plane | Spherical | Infinite | Infinite | | | | | | |
| | Stop | Spherical | Infinite | −0.750 | | | | | 5.622 | 5.622 |
| 1 | First | Aspherical | 19.251 | 1.980 | Plastic | 1.644 | 23.517 | −58.161 | 5.623 | 5.623 |
| 2 | lens | Aspherical | 12.207 | 0.200 | | | | | 5.390 | 5.390 |
| 3 | Second | Aspherical | 12.658 | 3.928 | Plastic | 1.546 | 55.974 | 231.413 | 5.408 | 5.408 |
| 4 | lens | Aspherical | 12.526 | 0.500 | | | | | 5.137 | 5.137 |
| 5 | Third | Aspherical | 13.571 | 2.404 | Plastic | 1.546 | 55.974 | 36.789 | 5.188 | 5.188 |
| 6 | lens | Aspherical | 39.235 | 1.302 | | | | | 5.092 | 5.092 |
| 7 | Fourth | Aspherical | 18.101 | 4.663 | Plastic | 1.546 | 55.974 | 885.141 | 5.010 | 5.010 |
| 8 | lens | Aspherical | 17.095 | 0.911 | | | | | 4.396 | 4.396 |
| 9 | Fifth | Aspherical | 17.567 | 2.813 | Plastic | 1.546 | 55.974 | 93.304 | 4.337 | 4.337 |
| 10 | lens | Aspherical | 25.299 | 5.538 | | | | | 3.982 | 3.982 |
| 11 | Special- | Spherical | Infinite | 3.500 | Glass | 1.518 | 64.166 | | 3.500 | 3.500 |
| 12 | shaped | Spherical | Infinite | −7.000 | | | | | 3.500 | 4.950 |
| 13 | prism | Spherical | Infinite | 7.000 | | | | | 4.950 | 3.500 |
| 14 | | Spherical | Infinite | −7.000 | | | | | 4.950 | 3.500 |
| 15 | | Spherical | Infinite | 3.500 | | | | | 3.500 | 4.950 |
| 16 | | Spherical | Infinite | 6.538 | | | | | 3.500 | 3.500 |
| 17 | Filter | Spherical | Infinite | 0.210 | Glass | 1.518 | 64.166 | | 2.552 | 2.552 |
| 18 | | | | 3.926 | | | | | 2.547 | 2.547 |
| | Image plane | Spherical | Infinite | | | | | | 2.400 | 2.400 |

TABLE 6

| Surface Number | 1 | 2 | 3 | 4 | 5 |
|---|---|---|---|---|---|
| K | 0.0000E+00 | 0.0000E+00 | 0.0000E+00 | 0.0000E+00 | 0.0000E+00 |
| A4 | −4.0649E−05 | −1.3158E−04 | −1.4568E−04 | −1.5190E−04 | −1.4862E−04 |
| A6 | −1.3224E−08 | 1.0136E−06 | 1.2718E−06 | 2.3178E−06 | 2.0340E−06 |
| A8 | 0.0000E+00 | 0.0000E+00 | 0.0000E+00 | 0.0000E+00 | 0.0000E+00 |
| A10 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 |
| Surface Number | 6 | 7 | 8 | 9 | 10 |
| K | 0.0000E+00 | 0.0000E+00 | 0.0000E+00 | 0.0000E+00 | 0.0000E+00 |
| A4 | −1.0655E−04 | 2.2988E−05 | 3.2060E−06 | 2.2114E−05 | 1.5990E−04 |
| A6 | 2.1675E−08 | 2.1755E−07 | −2.6825E−07 | 8.5308E−08 | 1.2797E−06 |
| A8 | 0.0000E+00 | 0.0000E+00 | 0.0000E+00 | 0.0000E+00 | 0.0000E+00 |
| A10 | 0.0000E+00 | 0.0000E+00 | 0.0000E+00 | 0.0000E+00 | 0.0000E+00 |
| A12 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 |

In addition, in this embodiment, the refraction or reflection of an incident light beam on the surfaces with corresponding numbers is given in the following Table:

| Number | Surface Name | | |
|---|---|---|---|
| | Object plane | | |
| | Stop | | |
| 1 | First lens | Refraction | |
| 2 | | Refraction | |
| 3 | Second lens | Refraction | |
| 4 | | Refraction | |
| 5 | Third lens | Refraction | |
| 6 | | Refraction | |
| 7 | Fourth lens | Refraction | |
| 8 | | Refraction | |
| 9 | Fifth lens | Refraction | |
| 10 | | Refraction | |
| 11 | Special-shaped prism | Refraction | |
| 12 | | Reflection | Eccentricity and bending |
| 13 | | Reflection | Eccentricity and bending |
| 14 | | Reflection | Eccentricity and bending |
| 15 | | Reflection | Eccentricity and bending |
| 16 | | Refraction | |
| 17 | Filter | Refraction | |
| 18 | | Refraction | |
| | Image plane | | |

The optical system 10 in this embodiment satisfies the following conditions:

| | | | |
|---|---|---|---|
| SDL/SDF | 1.138 | BFL/SDM | 4.47 |

In this embodiment, SDM is the maximum among the side lengths of the first reflective surface 1213, the second reflective surface 1214, the third reflective surface 1215, and the fourth reflective surface 1216. Referring to Table 5, 9.9 mm is the maximum among the side lengths of the four effective reflective surfaces 1203 mentioned above, and the SDM in this embodiment is thus 9.9 mm. The four sides of the first incident surface 1211 all have a length of 7 mm, thus the SDF in this embodiment is 7 mm.

### Fourth Embodiment

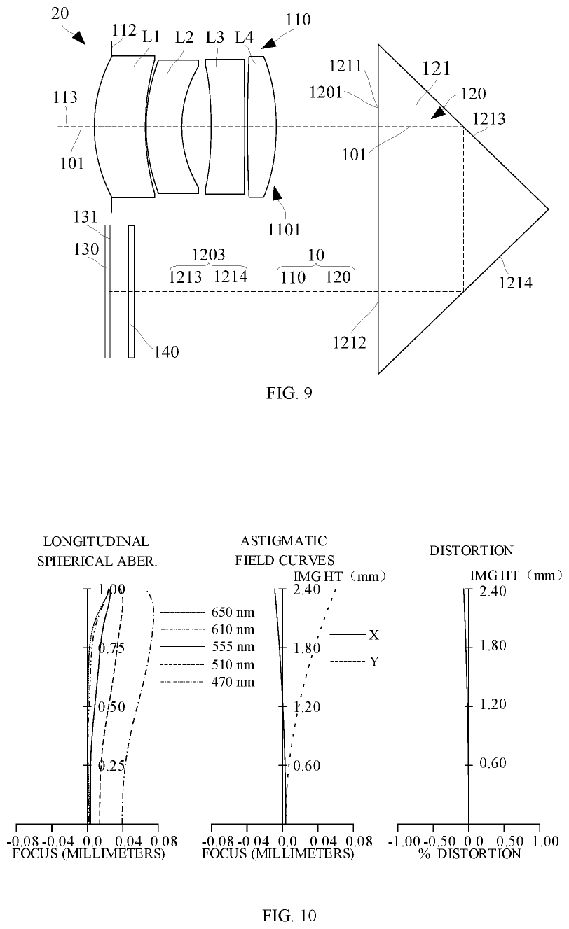

Referring to FIG. 9, in the fourth embodiment, a camera module 20 sequentially includes, along an incident optical path 101, an optical system 10, an infrared filter 140 (the filter in the Table below), and an image sensor 130. The optical system 10 sequentially includes, along the incident optical path 101, a lens element 110 and an optical path adjusting element 120. FIG. 10 shows diagrams of longitudinal spherical aberration, astigmatism, and distortion of the camera module 20 in the fourth embodiment.

The lens element 110 in this embodiment includes, sequentially from an object side toward an image side, a stop 112, a first lens L1 with a positive refractive power, a second lens L2 with a negative refractive power, a third lens L3 with a negative refractive power, and a fourth lens L4 with a positive refractive power. The first lens L1 includes an object-side surface and an image-side surface, the second lens L2 includes an object-side surface and an image-side surface, the third lens L3 includes an object-side surface and an image-side surface, and the fourth lens L4 includes an object-side surface and an image-side surface.

In addition, the first optical path element 121 in this embodiment is a right-angled triangular prism (i.e., the triangular prism shown in the following Table), and the first incident surface 1211 and the first emergent surface 1212 are part of the inclined surface of the right-angled triangular prism, i.e., the first incident surface 1211 and the first emergent surface 1212 are coplanar. By making the first incident surface 1211 and the first emergent surface 1212 coplanar, the light beam entering the first optical path element 121 can be finally emitted from the first optical path element 121 in the opposite direction, which can further reduce the dimension of the optical system 10 in the axial direction, so as to effectively realize the miniaturization design of the module. The two right-angled surfaces of the right-angled triangular prism correspond to one effective reflective surface 1203, respectively, i.e., correspond to the first reflective surface 1213 and the second reflective surface 1214, respectively.

In addition, the lens parameters in the fourth embodiment are given in Tables 7 and 8. The definitions of each structure and parameter can be obtained from the first embodiment, and will not be repeated here. However, it should be noted that Number 9 in Table 7 corresponds to the first incident surface 1211 of the first optical path element 121, Number 10 corresponds to the first reflective surface 1213, Number 11 corresponds to the second reflective surface 1214, and Number 12 corresponds to the first emergent surface 1212. The first incident surface 1211, the first reflective surface 1213, the second reflective surface 1214, and the first emergent surface 1212 are all rectangular planes, and the definitions of the X half aperture (mm) and the Y half aperture (mm) can refer to the description of the above-mentioned embodiment. For the first incident surface 1211 and the first emergent surface 1212 that are coplanar, the apertures of the two are virtual apertures, and the apertures are not directly reflected in the structure.

TABLE 7
Fourth Embodiment
f = 25.3 mm, FNO = 4.9, HFOV = 5.4°

| | | | | | | | | Focal | | |
|---|---|---|---|---|---|---|---|---|---|---|
| | Surface | Surface | Y radius | Thickness | | Refractive | Abbe | length | Y half | X half |
| Number | Name | Type | (mm) | (mm) | Material | index | number | (mm) | aperture | aperture |
| | Object plane | Spherical | Infinite | Infinite | | | | | | |
| | Stop | Spherical | Infinite | −0.612 | | | | | 2.582 | 2.582 |
| 1 | First | Spherical | 5.624 | 1.797 | Glass | 1.476 | 81.567 | 26.534 | 2.583 | 2.583 |
| 2 | lens | Spherical | 9.101 | 0.030 | | | | | 2.430 | 2.430 |
| 3 | Second | Aspherical | 6.737 | 1.254 | Plastic | 1.644 | 23.517 | −23.699 | 2.428 | 2.428 |
| 4 | lens | Aspherical | 4.333 | 1.036 | | | | | 2.215 | 2.215 |
| 5 | Third | Aspherical | −15.965 | 1.180 | Plastic | 1.537 | 55.751 | −33.590 | 2.240 | 2.240 |
| 6 | lens | Aspherical | −143.037 | 0.098 | | | | | 2.452 | 2.452 |
| 7 | Fourth | Aspherical | 65.516 | 1.015 | Plastic | 1.537 | 55.751 | 14.011 | 2.494 | 2.494 |
| 8 | lens | Aspherical | −8.449 | 3.592 | | | | | 2.565 | 2.565 |
| 9 | Triangular | Spherical | Infinite | 3.000 | Glass | 1.518 | 64.166 | | 3.000 | 3.000 |
| 10 | prism | Spherical | Infinite | −6.00 | | | | | 4.243 | 3.000 |
| 11 | | Spherical | Infinite | 3.000 | | | | | 4.243 | 3.000 |
| 12 | | Spherical | Infinite | 8.592 | | | | | 3.000 | 3.000 |
| 13 | Filter | Spherical | Infinite | 0.210 | Glass | 1.518 | 64.166 | | 2.408 | 2.408 |
| 14 | | Spherical | Infinite | 0.653 | | | | | 2.407 | 2.407 |
| | Image plane | Spherical | Infinite | | | | | | 2.402 | 2.402 |

TABLE 8
Fourth Embodiment
Aspherical coefficient

| Number | 3 | 4 | 5 | 6 | 7 | 8 |
|---|---|---|---|---|---|---|
| K | 0.0000E+00 | 0.0000E+00 | 0.0000E+00 | 0.0000E+00 | 0.0000E+00 | 0.0000E+00 |
| A4 | −4.4616E−04 | −2.4527E−04 | −9.0680E−04 | −4.6224E−05 | 5.5917E−05 | −7.4197E−04 |
| A6 | −2.1165E−05 | −9.9261E−05 | −1.8574E−04 | 7.0708E−07 | 6.7245E−06 | −6.4619E−05 |
| A8 | −6.4747E−07 | −5.8225E−06 | 6.2940E−06 | 2.2621E−06 | 3.8663E−07 | 3.1740E−06 |
| A10 | 4.2196E−07 | 1.2804E−06 | −1.0604E−06 | 6.5309E−07 | 1.4659E−07 | −5.7918E−07 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

In addition, in this embodiment, the refraction or reflection of an incident light beam on the surfaces with corresponding numbers is given in the following Table:

| Number | Surface Name | | |
|---|---|---|---|
| | Object plane | | |
| | Stop | | |
| 1 | First lens | Refraction | |
| 2 | | Refraction | |
| 3 | Second lens | Refraction | |
| 4 | | Refraction | |
| 5 | Third lens | Refraction | |
| 6 | | Refraction | |
| 7 | Fourth lens | Refraction | |
| 8 | | Refraction | |
| 9 | Triangular prism | Refraction | |
| 10 | | Reflection | Eccentricity and bending |
| 11 | | Reflection | Eccentricity and bending |
| 12 | | Refraction | |
| 13 | Filter | Refraction | |
| 14 | | Refraction | |
| | Image plane | | |

The optical system 10 in this embodiment satisfies the following conditions:

| | | | |
|---|---|---|---|
| SDL/SDF | 0.855 | BFL/SDM | 2.95 |

In this embodiment, SDL is a size of the maximum effective aperture of the image-side surface of the fourth lens L4. SDM is the maximum among the side lengths of the first reflective surface 1213, and the second reflective surface 1214. Referring to Table 7, 8.485 is the maximum among the side lengths of the two effective reflective surfaces 1203 mentioned above, and the SDM in this embodiment is thus 8.485 mm. In this embodiment, the first optical path element 120 is a right-angled triangular prism, the inclined surface of the first optical path element 120 is a 6 mm*12 mm rectangular surface, a half area of the inclined surface acts as the first incident surface 1211, and the other half area acts as the first emergent surface 1212. In this case, the X-direction half aperture and Y-direction half aperture of the first incident surface 1211 are both 3 mm, and the X-direction half aperture and Y-direction half aperture of the first emergent surface 1212 are both 3 mm. Therefore, the SDF in this embodiment is 6 mm.

### Fifth Embodiment

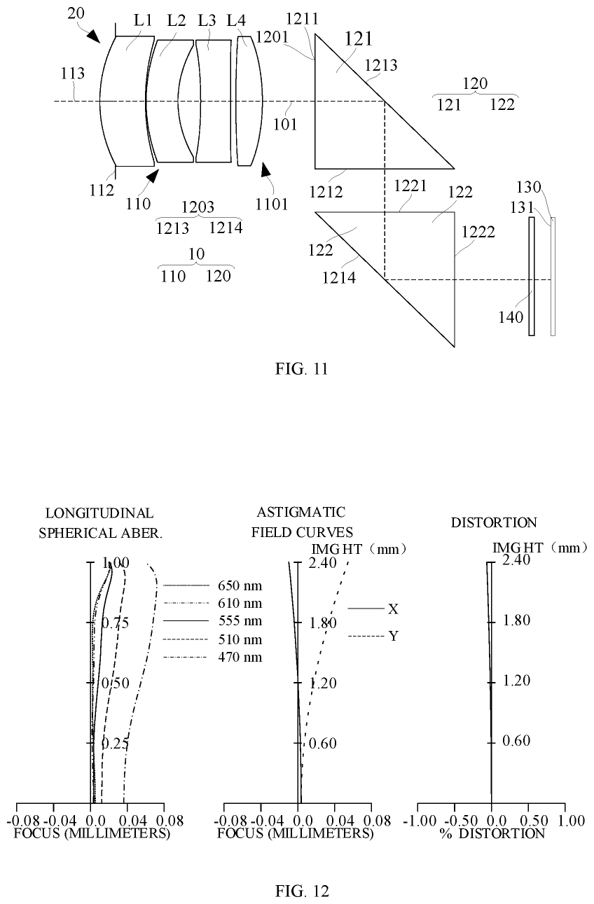

Referring to FIG. 11, in the fifth embodiment, a camera module 20 sequentially includes, along an incident optical path 101, an optical system 10, an infrared filter 140 (the filter in the Table below), and an image sensor 130. The optical system 10 sequentially includes, along the incident optical path 101, a lens element 110 and an optical path adjusting element 120. FIG. 12 shows diagrams of longitudinal spherical aberration, astigmatism, and distortion of the camera module 20 in the fifth embodiment.

The optical path adjusting element 120 includes a first optical path element 121 and a second optical path element 122. The first optical path element 121 and the second optical path element 122 are both right-angled triangular prisms. The upper triangular prism in the Table below is the first optical path element 121, and the lower triangular prism is the second optical path element 122. One right-angled surface of the first optical path element 121 is a first incident surface 1211, the other right-angled surface is a first emergent surface 1212, and an inclined surface acts as a first reflective surface 1213 of the optical path adjusting element 120. One right-angled surface of the second optical path element 122 is a second incident surface 1221, the other right-angled surface is a second emergent surface 1222, and an inclined surface acts as a second reflective surface 1214 of the optical path adjusting element 120. The second incident surface 1221 is directly opposite to the first emergent surface 1212, and the second emergent surface 1222 is directly opposite to the infrared filter 140. The light beam emitted from the first reflective surface 1213 of the first optical path element 121 can enter the second optical path element 122 from the second incident surface 1221, and is internally reflected at the second reflective surface 1214, and then is emitted from the second emergent surface 1222 to the infrared filter 140, and finally reaches the image sensor 130.

The lens parameters in the fifth embodiment are given in Tables 9 and 10. The definitions of each structure and parameter can be obtained from the first embodiment, and will not be repeated here. However, it should be noted that Number 9 corresponds to the first incident surface 1211 of the first optical path element 121, Number 10 corresponds to the first reflective surface 1213, Number 11 corresponds to the first emergent surface 1212, Number 12 corresponds to the second incident surface 1221, Number 13 corresponds to the second reflective surface 1214, and Number 14 corresponds to the second emergent surface 1222. The first incident surface 1211, the first reflective surface 1213, the first emergent surface 1212, the second incident surface 1221, the second reflective surface 1214, and the second emergent surface 1222 are all rectangular planes, and the definitions of the X half aperture and the Y half aperture of each surface can refer to the description of the above-mentioned embodiment.

TABLE 9
Fifth Embodiment
f = 25.9 mm, FNO = 4.9, HFOV = 5.3°

| | | | | | | | | Focal | | |
|---|---|---|---|---|---|---|---|---|---|---|
| | Surface | Surface | Y radius | Thickness | | Refractive | Abbe | length | Y half | X half |
| Number | Name | Type | (mm) | (mm) | Material | index | number | (mm) | aperture | aperture |
| | Object plane | Spherical | Infinite | Infinite | | | | | | |
| | Stop | Spherical | Infinite | −0.612 | | | | | 2.642 | 2.642 |
| 1 | First | Spherical | 5.724 | 1.797 | Glass | 1.476 | 81.567 | 28.027 | 2.646 | 2.646 |
| 2 | lens | Spherical | 9.016 | 0.030 | | | | | 2.489 | 2.489 |
| 3 | Second | Aspherical | 6.805 | 1.254 | Plastic | 1.644 | 23.517 | −24.309 | 2.486 | 2.486 |
| 4 | lens | Aspherical | 4.401 | 0.896 | | | | | 2.273 | 2.273 |
| 5 | Third | Aspherical | −17.717 | 1.180 | Plastic | 1.537 | 55.751 | −32.421 | 2.284 | 2.284 |
| 6 | lens | Aspherical | 1000.0 | 0.206 | | | | | 2.483 | 2.483 |
| 7 | Fourth | Aspherical | 46.157 | 1.047 | Plastic | 1.537 | 55.751 | 13.800 | 2.551 | 2.551 |
| 8 | lens | Aspherical | −8.753 | 2.075 | | | | | 2.624 | 2.624 |
| 9 | Triangular | Spherical | Infinite | 2.750 | Glass | 1.518 | 64.166 | | 2.750 | 2.750 |
| 10 | prism | Spherical | Infinite | −2.75 | | | | | 3.889 | 2.750 |
| 11 | | Spherical | Infinite | −1.764 | | | | | 2.750 | 2.750 |
| 12 | Triangular | Spherical | Infinite | −2.75 | Glass | 1.518 | 64.166 | | 2.750 | 2.750 |
| 13 | prism | Spherical | Infinite | 2.750 | | | | | 3.889 | 2.750 |
| 14 | | Spherical | Infinite | 9.689 | | | | | 2.750 | 2.750 |
| 15 | Filter | Spherical | Infinite | 0.210 | Glass | 1.518 | 64.166 | | 2.410 | 2.410 |
| 16 | | Spherical | Infinite | 0.653 | | | | | 2.408 | 2.408 |
| | Image plane | Spherical | Infinite | 0.000 | | | | | 2.402 | 2.402 |

TABLE 10
Fifth Embodiment
Aspherical coefficient

| Number | 3 | 4 | 5 | 6 | 7 | 8 |
|---|---|---|---|---|---|---|
| K | 0.0000E+00 | 0.0000E+00 | 0.0000E+00 | 0.0000E+00 | 0.0000E+00 | 0.0000E+00 |
| A4 | −4.9167E−04 | −3.3290E−04 | −7.3048E−04 | −2.6595E−05 | 1.3399E−05 | −6.7072E−04 |
| A6 | −2.2552E−05 | −1.1261E−04 | −1.7155E−04 | 1.8648E−05 | −9.9874E−06 | −7.8356E−05 |
| A8 | −8.4917E−07 | −7.7312E−06 | 1.0738E−05 | 5.9636E−06 | −1.6917E−06 | 2.1013E−06 |
| A10 | 4.0532E−07 | 1.8004E−06 | −5.3082E−07 | 8.8726E−07 | 6.9012E−07 | −4.8316E−07 |
| A12 | 0.0000E+00 | 0.0000E+00 | 0.0000E+00 | 0.0000E+00 | 0.0000E+00 | 0.0000E+00 |
| A14 | 0.0000E+00 | 0.0000E+00 | 0.0000E+00 | 0.0000E+00 | 0.0000E+00 | 0.0000E+00 |
| A16 | 0.0000E+00 | 0.0000E+00 | 0.0000E+00 | 0.0000E+00 | 0.0000E+00 | 0.0000E+00 |
| A18 | 0.0000E+00 | 0.0000E+00 | 0.0000E+00 | 0.0000E+00 | 0.0000E+00 | 0.0000E+00 |
| A20 | 0.0000E+00 | 0.0000E+00 | 0.0000E+00 | 0.0000E+00 | 0.0000E+00 | 0.0000E+00 |

In addition, in this embodiment, the refraction or reflection of an incident light beam on the surfaces with corresponding numbers is given in the following Table:

| Number | Surface Name | | |
|---|---|---|---|
| | Object plane | | |
| | Stop | | |
| 1 | First lens | Refraction | |
| 2 | | Refraction | |
| 3 | Second lens | Refraction | |
| 4 | | Refraction | |
| 5 | Third lens | Refraction | |
| 6 | | Refraction | |
| 7 | Fourth lens | Refraction | |
| 8 | | Refraction | |
| 9 | Triangular prism | Refraction | |
| 10 | | Reflection | Eccentricity and bending |
| 11 | | Refraction | |
| 12 | Triangular prism | Refraction | |
| 13 | | Reflection | Eccentricity and bending |
| 14 | | Refraction | |
| 15 | Filter | Refraction | |
| 16 | | Refraction | |
| | Image plane | | |

The optical system 10 in this embodiment satisfies the following conditions:

| | | | |
|---|---|---|---|
| SDL/SDF | 0.954 | BFL/SDM | 3.26 |

In this embodiment, SDL is a size of an effective aperture of the image-side surface of the fourth lens L4. SDM is the maximum among the side lengths of the first reflective surface 1213, and the second reflective surface 1214. Referring to Table 9, the Y-direction apertures of the effective reflective surfaces 1203 corresponding to Numbers 10 and 13 are the maximum among the side lengths of the respective effective reflective surfaces 1203, respectively, and the SDM in this embodiment is thus 7.778 mm. The X-direction half aperture and the Y-direction half aperture of the first incident surface 1211 both have a length of 2.75 mm, thus the SDF in this embodiment is 5.5 mm.

As mentioned above, in the schematic views corresponding to the embodiments, the positional distances between the elements, sizes, and the like are not drawn strictly in scale, and the specific data shall be subject to the parameters in the tables.

In addition to the pentaprism and the right-angled triangular prism in the foregoing embodiments, the first optical path element 121 may also be a polygonal prism such as a quadrangular prism and a hexaprism in some embodiments. Similarly, in addition to the right-angled triangular prism, the second optical path element 122 may also be a polygonal prism such as a quadrangular prism, a pentaprism, and a hexaprism in some embodiments. When the first optical path element 121 and/or the second optical path element 122 are in a prism structure, at least one side surface of the prism structure serves as an effective reflective surface 1203, and the incident light beam is internally reflected at the corresponding effective reflective surface 1203. In some embodiments, the second optical path element 122 may also have a flat structure, and the surface on one side of the flat structure serves as the effective reflective surface 1203, and the incident light beam is externally reflected at the effective reflective surface 1203. As mentioned above, for the arrangement of the effective reflective surface 1203 in each embodiment, a reflective coating may be provided on the surface of at least one side of a prism or other structure that can serve as the first optical path element 121 and the second optical path element 122, so as to enable the corresponding surface to have the effect of reflecting the incident light beam, thereby forming an effective reflective surface 1203.

In some embodiments, the first incident surface 1211, the first emergent surface 1212, each effective reflective surface 1203, the second incident surface 1221, and the second emergent surface 1222 may be circular planes in addition to rectangular planes. And the aperture of each surface can be provided with a light-shielding coating on the corresponding surface to retain only the required light-passing area, and the aperture of the light-passing area is the effective clear aperture of the surface.

In some embodiments, the distance between the lenses in the lens element 110 is relatively fixed, and the camera module 20 is a fixed focus module. In other embodiments, a driving mechanism such as a voice coil motor may be provided to enable relative movement between the lenses in the lens element 110, thereby achieving a zoom effect. Specifically, a coil electrically connected to a driving chip is provided on a lens barrel that is equipped with the above-mentioned lenses, and a magnet is provided near the lens element 110. The magnetic force between the energized coil and the magnet drives the relative movement between the lenses, so as to achieve the optical zoom effect.

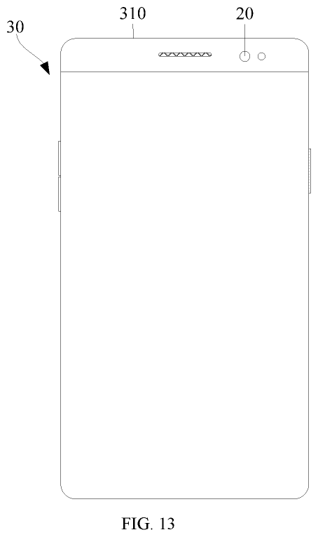

Referring to FIG. 13, some embodiments of the present disclosure further provide an electronic device 30 to which the camera module 20 is applied so as to provide the electronic device 30 with a camera function. Specifically, the electronic device 30 includes a fixing member 310 on which the camera module 20 is mounted. The fixing member 310 may be a component such as a circuit board, a middle frame, or the like. The electronic device 30 may be, but is not limited to, smart phones, smart watches, e-book readers, in-vehicle camera equipment (such as drive recorder), monitoring devices, medical devices (such as endoscope), tablet computers, biometric devices (such as fingerprint recognition device or pupil recognition device, etc.)), PDA (Personal Digital Assistant), and unmanned aerial vehicles, or the like. Specifically, in an embodiment, the electronic device 30 is a smart phone including a middle frame and a circuit board disposed in the middle frame. The camera module 20 is mounted in the middle frame of the smart phone, and the image sensor therein is electrically connected to the circuit board. The camera module 20 can be used as a front camera module or a rear camera module of a smart phone. The camera module 20 in the above-mentioned embodiments of the present disclosure has the characteristics of telephoto, high image brightness, and small dimension. Therefore, by using the above-mentioned camera module 20, the electronic device 30 will be able to achieve the telephoto performance while having the characteristics of a sufficiently bright shooting screen and miniaturization (such as ultra-thinness).

In the description of the present disclosure, it should be understood that the terms “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, “circumferential”, etc. indicate that the orientation or positional relationship is based on the orientation or positional relationship shown in the drawings, which is only for the purpose of facilitating the description of the present disclosure and simplifying the description, rather than indicating or implying that the device or elements must have a specific orientation, be constructed and operated in a specific orientation, and therefore cannot be construed as limitation of the present disclosure.

In addition, the terms “first” and “second” are used for descriptive purposes only, and cannot be understood to indicate or imply relative importance or implicitly indicate the number of technical features indicated. Therefore, the features defined by “first” and “second” may explicitly or implicitly include at least one of the features. In the description of the present disclosure, the term “plurality” means at least two, such as two, three, etc., unless specifically defined otherwise.

In the present disclosure, unless otherwise clearly specified and limited, the term such as “mounted”, “interconnected”, “connected”, “fixed” should be understood in a broad sense, for example, it can be a fixed connection or a detachable connection, or integrated; may be a mechanical connection or an electrical connection; may be a direct connection, or may be an indirect connection through an intermediate, may be a communication between two components or an interaction between two components, unless otherwise specified. Those ordinary skilled in the art can understand the specific meanings of the above terms in the present disclosure according to specific situations.

In the present disclosure, unless otherwise clearly specified and defined, the expression that a first feature is “above” or “below” a second feature may indicate that the first and second features are in direct contact, or the first and second features are in indirectly contact through an intermediate. The expression that a first feature is “on”, “above”, and “over” a second feature may indicate that the first feature is directly or obliquely above the second feature, or only indicates that the horizontal height of the first feature is higher than that of the second feature. The expression that a first feature is “beneath”, “below”, and “under” the second feature may indicate that the first feature is directly or obliquely below the second feature, or only indicates that the horizontal height of the first feature is lower than that of the second feature.

In the description of the present specification, descriptions with reference to the terms such as “an embodiment”, “some embodiments”, “examples”, “specific examples”, or “some examples” mean the specific features, structures, materials or characteristics described in conjunction with these embodiments or examples are included in at least one embodiment or example of the present disclosure. In the present specification, the schematic representations for the above terms do not necessarily refer to the same embodiment or example. Moreover, the described specific features, structures, materials or characteristics can be combined in any one or more embodiments or examples in a suitable manner. In addition, those skilled in the art can combine the different embodiments or examples and the features of the different embodiments or examples described in this specification without contradicting each other.

The technical features of the above embodiments can be combined arbitrarily. For concise description, not all possible combinations of the technical features in the above embodiments are described, but all of which should be considered to be within the scope described in this specification, as long as there is no contradiction between them.

The above-mentioned embodiments are merely illustrative of several embodiments of the present disclosure, which are described specifically and in detail, and cannot be understood to limit the scope of the present disclosure. It should be noted that, for those ordinary skilled in the art, several variations and improvements may be made without departing from the concept of the present disclosure, and all of which are within the protection scope of the present disclosure. Therefore, the protection scope of the present disclosure shall be defined by the appended claim.

What is claimed is:

1. An optical system comprising, sequentially along an incident optical path:
a lens element comprising at least one lens and having a positive refractive power; and
an optical path adjusting element comprising an incident surface and at least one effective reflective surface, the incident surface facing an image side of the lens element, and a light beam from the lens element being capable of passing through the incident surface to enter the optical path adjusting element, and being reflected at the effective reflective surface,
wherein the optical system satisfies the following condition:
SDL/SDF<1.5
wherein SDL is a size of an aperture of an image-side surface of a lens closest to the image side in the lens element, and SDF is a size of an aperture of the incident surface.

2. The optical system according to claim 1, wherein the optical path adjusting element comprises a first optical path element comprising a first incident surface, a first emergent surface, and two effective reflective surfaces, the first incident surface is the incident surface of the optical path adjusting element, the two effective reflective surfaces are a first reflective surface and a second reflective surface, respectively, and the incident optical path sequentially passes through the first incident surface, the first reflective surface, the second reflective surface, and the first emergent surface.

3. The optical system according to claim 2, wherein the first optical path element is a triangular prism or a pentaprism.

4. The optical system according to claim 2, wherein one end of the first incident surface is connected to the first emergent surface, and the other end oppositely is connected to the second reflective surface; the first emergent surface is connected to the first reflective surface at an end away from the first incident surface; the first incident surface is perpendicular to the first emergent surface, and the first incident surface and the second reflective surface form an angle of 112.5°, and the first emergent surface and the first reflective surface form an angle of 112.5°.

5. The optical system according to claim 2, wherein the first incident surface and the first emergent surface are coplanar.

6. The optical system according to claim 5, wherein the first optical path element is a triangular prism, and the first incident surface and the first emergent surface both are inclined surfaces of the first optical path element.

7. The optical system according to claim 1, wherein the optical path adjusting element comprises a first optical path element comprising a first incident surface, a first emergent surface, and four effective reflective surfaces, the first incident surface is the incident surface of the optical path adjusting element, the four effective reflective surfaces are a first reflective surface, a second reflective surface, a third reflective surface, and a fourth reflective surface, respectively, and the incident optical path sequentially passes through the first incident surface, the first reflective surface, the second reflective surface, the third reflective surface, the fourth reflective surface, and the first emergent surface.

8. The optical system according to claim 7, wherein the incident optical path between the first incident surface and the first reflective surface is a first optical path, the incident optical path between the first reflective surface and the second reflective surface is a second optical path, the incident optical path between the second reflective surface and the third reflective surface is a third optical path, the incident optical path between the third reflective surface and the fourth reflective surface is a fourth optical path, and the incident optical path between the fourth reflective surface and the first emergent surface is a fifth optical path; the optical system comprises a first direction and a second direction, the first direction is perpendicular to the second direction, and both the first direction and the second direction are perpendicular to an optical axis of the lens element;
the first optical path is collinear with the optical axis of the lens element, the second optical path is perpendicular to the first optical path, the third optical path is perpendicular to the first optical path and the second optical path, respectively, the fourth optical path is parallel to the second optical path, and the fifth optical path is parallel to the first optical path.

9. The optical system according to claim 8, wherein the first incident surface is parallel to the first emergent surface.

10. The optical system according to claim 8, wherein the first reflective surface and the first incident surface form an angle of 45°, the second reflective surface and the third reflective surface are perpendicular to the first incident surface, and the second reflective surface is perpendicular to the third reflective surface, and the fourth reflective surface forms an angle of 45° with the first incident surface and the first emergent surface, respectively.

11. The optical system according to claim 1, wherein the optical path adjusting element comprises a first optical path element and a second optical path element, the first optical path element comprises a first incident surface, a first emergent surface, and at least one effective reflective surface, the first incident surface is the incident surface of the optical path adjusting element, the first emergent surface faces the second optical path element comprising at least one effective reflective surface, and the incident optical path sequentially passes through the first incident surface, each effective reflective surface of the first optical path element, and the first emergent surface, then passes through the effective reflective surface of the second optical path element, and finally reaches an imaging plane of the optical system.

12. The optical system according to claim 11, wherein the first optical path element is a triangular prism or a pentaprism.

13. The optical system according to claim 11, wherein the second optical path element is a triangular prism.

14. The optical system according to claim 1, satisfying the following condition:
BFL/SDM>2
wherein BFL is a distance on the incident optical path from a center of the image-side surface of the lens closest to the image side in the lens element toward an imaging plane of the optical system, and SDM is a maximum value among apertures of all the effective reflective surfaces.

15. The optical system according to claim 1, wherein the lens element comprises a first lens having a positive refractive power, a second lens having a negative refractive power, and a third lens having a positive refractive power.

16. The optical system according to claim 1, wherein the lens element comprises a first lens having a negative refractive power, a second lens having a positive refractive power, a third lens having a positive refractive power, a fourth lens having a positive refractive power, and a fifth lens having a positive refractive power.

17. The optical system according to claim 1, wherein the lens element comprises a first lens having a positive refractive power, a second lens having a negative refractive power, a third lens having a negative refractive power, and a fourth lens having a positive refractive power.

18. A camera module, comprising an image sensor and the optical system according to claim 1, and the image sensor being configured to receive a light beam from the optical path adjusting element.

19. The camera module according to claim 18, comprising an infrared filter disposed between the optical system and the image sensor along the incident optical path.

20. An electronic device, comprising a fixing member and the camera module according to claim 18 arranged on the fixing member.
